(19) United States
(12) Patent Application Publication
(10) Pub. No.: US 2012/0101200 A1
(43) Pub. Date: Apr. 26, 2012

(54) Innovative long-lasting biobased plastics based on polyhydroxyalkanoate, a method for producing them and use thereof

(75) Inventors: Andrea Fruth, Wiesbaden (DE); Ana Maria Cano Sierra, Heidelberg (DE); Armin Eckert, Oberhausen-Rheinhausen (DE); Andreas Krug, Mannheim (DE); Bernd Wiloth, Ketsch (DE)

(73) Assignee: RHEIN CHEMIE RHEINAU GMBH, Mannheim (DE)

(21) Appl. No.: 13/196,962

(22) Filed: Aug. 3, 2011

(30) Foreign Application Priority Data
Aug. 11, 2010 (DE) 10172530.7

(51) Int. Cl. C08K 5/29; C08L 67/04

(52) U.S. Cl. 524/195

(57) ABSTRACT

The present invention provides innovative long-lasting and hydrolysis-stable biobased plastics based on polyhydroxyalkanoate (PHA), a method for producing them and their use.

The present invention provides innovative long-lasting and hydrolysis-stable biobased plastics based on polyhydroxyalkanoate (PHA), a method for producing them and their use.

Biobased plastics, known as biopolymers, are more environmentally sustainable materials than petrochemically based plastics, on account of the biobased raw materials employed. Particularly in respect of environmental protection and of the onset of climatic warming, biobased plastics have acquired increasing importance not only in the packing sector but also in the production of long-lasting and industrial plastics products. In order, however, to make biobased materials based on polyhydroxyalkanoates competitive in comparison to conventional and established materials, optimizations are still necessary in many cases in the production and processing of the material.

Biobased plastics are composed, for example, of an aliphatic polyester resin which is produced by direct fermentative preparation from starch, sugar, carbohydrates, vegetable oil or fats.

Biobased plastics have the great advantage that they are very eco-friendly. In the area of industrial applications, from among the group of biopolymers, polyhydroxyalkanoates in particular have the advantage that they possess, for example, a greater heat distortion resistance in comparison to polylactic acid (PLA). This allows the production of long-lasting articles which cannot be employed made from polylactic acid on account of the low softening point, examples of such articles being kettles and hairdryers. Furthermore, polyhydroxyalkanoates exhibit very little shrinkage in manufactured products, thereby allowing product geometries which are unrealizable with conventional polymers. In comparison to polylactic acid, the product class of the polyhydroxyalkanoates is far less sensitive to hydrolysis. Nevertheless, polyhydroxyalkanoates have the disadvantage that for long-lasting and industrial applications their stability to hydrolysis is inadequate, and, moreover, that they have poor processing properties.

Both polylactic acid and polyhydroxyalkanoates belong to the class of aliphatic polyesters and are both susceptible to polymer degradation during processing and in the course of the application. The degradation mechanism in the case of polylactic acid runs along the classic path of an ester hydrolysis, where the action of acids or bases in the presence of water is accompanied by a cleavage of the ester bond in the polylactic acid, thereby generating new hydroxyl groups and carboxyl groups.

—COO—+H₂O→—COOH+HO—

The new carboxyl groups result in hydrolysis of further ester groups in the polylactic acid polymer—that is, the process proceeds autocatalytically. Ester cleavage in the polylactic acid leads, consequently, to polymer degradation and hence to a reduction in the lifetime of the polylactic acid, and also to an unstable operational regime.

In comparison to polylactic acid, however, the product class of the polyhydroxyalkanoates is far less sensitive to hydrolysis. This difference in susceptibility to hydrolysis is a result of the different degradation mechanism. In the case of polyhydroxyalkanoates, in contrast to polylactic acid, a different degradation mechanism, that of a β-elimination, is predominant. This β-elimination results in the cleavage of the polyhydroxyalkanoate polymer chain with formation of unsaturated polymer fragments; see Yoshihiro Aoyagi, et al., Polymer Degradation and Stability 76, 2002, 53-59

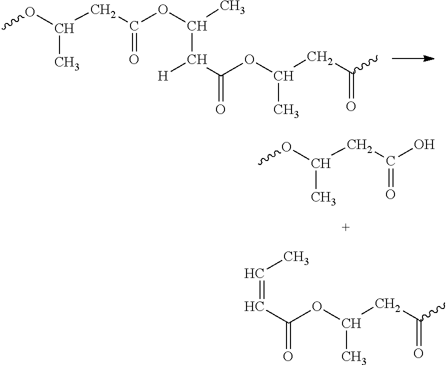

In comparison to polylactic acid, the hydrolytic degradation of polyhydroxyalkanoates plays a minor part, but may likewise occur, since PHAs are also aliphatic polyesters. In spite of the different degradation mechanism, polyhydroxyalkanoates have the disadvantage that for long-lasting and industrial applications they do not possess sufficient stability to hydrolysis, and, moreover, have poor processing properties, as manifested in a sharp drop in the melt volume rate (MVR). It is therefore necessary to look for a possibility of achieving stabilization of PHA during processing and during application, in spite of the combination of the largely prevailing β-elimination and the hydrolysis which nevertheless likewise occurs.

Attempts have been made to solve this problem through the addition of a wide variety of additives. For example, the abstract of JP-A 2008 303 286 describes the use of 0.5% by weight of a polymeric carbodiimide in polyhydroxyalkanoates. In relation to the stability to hydrolysis, however, no satisfactory result is achieved here. The same applies to the abstract of WO 2009119512, which cites the use of a polycarbodiimide from mixtures of polybutylene succinate and also blends of polybutylene succinate with polyhydroxyalkanoates among other co-components. Here as well, however, no sufficient hydrolysis resistance is obtained.

EP-A 1 627 894 describes the use of diisopropylphenylcarbodiimide as a hydrolysis inhibitor in aliphatic polyester resins. In terms of the processing properties, however, no satisfactory outcome is achieved.

The antioxidants additionally used in EP-A 1 354 917 do reduce the yellowing, but do not increase the stability.

The object is therefore to provide innovative long-lasting biobased plastics on the basis of polyhydroxyalkanoates that do not have the disadvantages of the prior art and that possess high stability to hydrolysis and good processing properties.

Surprisingly it has now been found that the biobased plastics of the invention from the class of the polyhydroxyalkanoates, comprising a combination of at least one monomeric and at least one oligomeric and/or polymeric carbodiimide, fulfil this object.

The present invention accordingly provides biobased plastics comprising a combination of at least one polyhydroxyalkanoate and at least one aromatic monomeric and one aromatic oligomeric and/or aromatic polymeric carbodiimide.

The biobased plastics in the sense of the invention are preferably polyhydroxyalkanoates which can be produced by direct fermentative preparation from starch, sugar, carbohydrates, vegetable oil or fats. Additionally possible for use are aliphatic-aromatic polyester resins, such as polytrimethylene terephthalate (PTT), polybutylene terephthalate (PBT), polybutylene adipate terephthalate (PBAT), polybutylene succinate terephthalate (PBST), for example. Included here as well are blends with biobased plastics, such as with polylactic acid (PLA), polycarbonate, starch, polybutylene terephthalate (PBT), polyamide, polybutylene adipate terephthalate (PBAT), for example.

Polyhydroxyalkanoates are compounds of the structural formula (I)

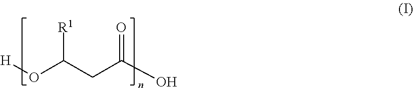

where R¹=C₁- to C₁₄-alkyl. Particularly preferred are polyhydroxybutyrate (PHB), polyhydroxyvalerate (PHV), polyhydroxybutyrate valerate (PHBV), polyhydroxyhexanoate (PHH), polyhydroxyoctanoate (PHO), polyhydroxybutyrate hexanoate (PHBH) and mixtures thereof.

The polyhydroxyalkanoates particularly preferred as biobased plastics are available commercially, such as for example under the name Mirel from the company Telles or as Enmat from the company Tianan, or can be prepared by the methods familiar to the skilled person, such as by fermentation, for example.

As monomeric, oligomeric and/or polymeric carbodiimides, use may be made of all known aromatic carbodiimides.

The polymeric and/or oligomeric carbodiimide is preferably a compound of the general formula (II),

R²—(—N═C═N—R′—)ₘ—R³ (II),

in which
R′ is an aromatic and/or araliphatic radical, R′ within the molecule is identical or different and, in the case of different combinations, each of the aforementioned radicals may be combined arbitrarily with one another, R′ in the case of aromatic oligomeric or polymeric carbodiimides may carry no aliphatic and/or cycloaliphatic and/or aromatic substituents having at least one carbon atom, it also being possible for these substituents to carry heteroatoms, or may carry such substituents in at least one position ortho to the aromatic carbon atom which carries the carbodiimide group,
R²=C₁-C₁₈-alkyl, C₅-C₁₈-cycloalkyl, aryl, C₇-C₁₈-aralkyl, —R′—NH—COS—R⁴, —R′COOR⁴, —R′—OR⁴, —R′—N(R⁴)₂, —R′—SR⁴, R′—NH₂, —R′—NHR⁴, —R′-epoxy, R′—NCO, —R′—NHCONHR⁴, —R′—NHCONR⁴R⁵ or —R′—NHCOOR⁶ and
R³=—N═C═N-aryl, —N═C═N-alkyl, —N═C═N-cycloalkyl, —N═C═N-aralkyl, —NCO, —NHCONHR⁴, —NHCONHR⁴R⁵, —NHCOOR⁶, —NHCOS—R⁴, —COOR⁴, —OR⁴, epoxy, —N(R⁴)₂, —SR⁴, —OH, —NH₂, —NHR⁴,
and in R² and R³, independently of one another, R⁴ and R⁵ are identical or different and are a C₁-C₂₀-alkyl-, C₃-C₂₀-cycloalkyl, C₇-C₁₈-aralkyl radical, oligo-/polyethylene glycols and/or oligo-/polypropylene glycols and R⁶ has one of the definitions of R⁴ or is a polyester radical or a polyamide radical, and
in the case of oligomeric carbodiimides, m corresponds to an integer from 1 to 5, and
in the case of polymeric carbodiimides, m corresponds to an integer >5.

In the case of the oligomeric and/or polymeric carbodiimides, particular preference for R′ is given to 1,3-substituted 2,4,6-triisopropylphenyl, 4,4′-substituted dicyclohexylmethane derivatives, isophorone derivatives, 1,3-bis(1-methyl-1-isocyanatoethyl)benzene, tetramethylxylylene derivatives, 2,4-substituted tolylene, 2,6-substituted tolylene and/or mixtures of 2,4- or 2,6-substituted tolylene.

In another preferred embodiment of the invention, the biobased plastic further comprises an aromatic carbodiimide, very preferably an aromatic sterically hindered carbodiimide.

In another preferred embodiment of the invention, the monomeric carbodiimide is a compound of the formula (III)

R″—N═C═N—R′″ (III),

in which
R″ and R′″ are identical or different and correspond to aryl, C₇-C₁₈-aralkyl, R″ and R′″, in the case of an aromatic radical, may carry no aliphatic and/or cycloaliphatic and/or aromatic substituents having at least one carbon atom, it also being possible for the substituents to carry heteroatoms, or may carry such substituents in at least one position ortho to the aromatic carbon atom which carries the carbodiimide group.

Particularly preferred as aromatic monomeric carbodiimide are sterically hindered aromatic carbodiimides of the general formula (IV),

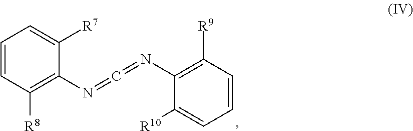

in which R⁷ to R¹⁰ independently of one another are H, C₁- to C₂₀-alkyl, C₃- to C₂₀-cycloalkyl, C₆- to C₁₅-aryl or a C₆- to C₁₅-aralkyl radical which optionally may also contain heteroatoms.

In one preferred embodiment of the present invention it is possible to use a combination of an aromatic monomeric and oligomeric and/or polymeric carbodiimides.

In a further, likewise preferred embodiment of the invention, the monomeric and at least one oligomeric and/or polymeric carbodiimides used are sterically hindered.

The aforementioned monomeric carbodiimides and also the oligomeric/polymeric carbodiimides are, in the case of the compounds of the formulae (II) to (IV), commercially obtainable compounds which are obtainable, for example, from Rhein Chemie Rheinau GmbH.

Also possible as well is the preparation of the carbodiimides by the methods described in U.S. Pat. No. 2,941,956, for example, or by the condensation of diisocyanates with elimination of carbon dioxide at elevated temperatures, e.g. at 40° C. to 200° C., in the presence of catalysts. Suitable methods are described in DE-A-11 30 594 and in DE-B-11 305-94. Examples of catalysts which have been found appropriate include strong bases or phosphorus compounds. Preference is given to using phospholene oxides, phospholidines or phospholine oxides, and also the corresponding sulphides. As catalysts it is possible, furthermore, to use tertiary amines, basic metal compounds, metal salts of carboxylic acids, and non-basic organometallic compounds.

For preparing the carbodiimides and/or polycarbodiimides used, all isocyanates are suitable, with preference being given in the context of the present invention to the use of carbodiimides and/or polycarbodiimides that are based on aromatic isocyanates substituted by C₁- to C₄-alkyl, such as, for example, 2,6-diisopropylphenyl isocyanate, 2,4,6-triisopropylphenyl 1,3-diisocyanate, 2,4,6-triethylphenyl 1,3-diisocyanate, 2,4,6-trimethylphenyl 1,3-diisocyanate, 2,4′-diisocyanatodiphenylmethane, 3,3′,5,5′-tetraisopropyl-4,4′-diisocyanatodiphenylmethane, 3,3′,5,5′-tetraethyl-4,4′-diisocyanatodiphenylmethane, tetramethylxylene diisocyanate, 1,5-naphthalene diisocyanate, 4,4′-diphenylmethane diisocyanate, 4,4′-diphenyldimethylmethane diisocyanate, 1,3-phenylene diisocyanate, 1,4-phenylene diisocyanate, 2,4-tolylene diisocyanate, 2,6-tolylene diisocyanate, a mixture of 2,4-tolylene diisocyanate and 2,6-tolylene diisocyanate, xylylene diisocyanate, tetramethylxylylene diisocyanate, 2,6-diisopropylphenylene isocyanate and 1,3,5-triisopropylbenzene 2,4-diisocyanate or mixtures thereof, or are based on substituted aralkyls, such as 1,3-bis(1-methyl-1-isocyanatoethyl)benzene. It is particularly preferred if the carbodiimides and/or polycarbodiimides are based on 2,4,6-triisopropylphenyl 1,3-diisocyanate, 2,6-diisopropylphenylene isocyanate, 1,3-bis(1-methyl-1-isocyanatoethyl)benzene, tetramethylxylylene diisocyanate, 2,4-tolylene diisocyanate, 2,6-tolylene diisocyanate and/or mixtures of 2,4- and 2,6-tolylene diisocyanate.

The fraction of carbodiimide in the polyhydroxyalkanoate is preferably 0.1%-5%.

In a further preferred embodiment of the present invention, the total amount of carbodiimides, based on the plastic, is at least 0.5%, more preferably ≧0.9% by weight.

In one preferred embodiment, furthermore, the ratio of monomeric to oligomeric and/or polymeric carbodiimide is 10:1 to 1:10, particular preference being given to a ratio of 3:1 to 1:3.

It is preferred, furthermore, for the fraction of polyhydroxyalkanoate in the biobased plastic to be 5-99.5%, more preferably 20-99%.

The present invention further provides a method for producing the biobased plastics of the invention, whereby at least one polyhydroxyalkanoate is mixed with at least one monomeric aromatic and at least one aromatic oligomeric and/or aromatic polymeric carbodiimide in a mixing assembly. The carbodiimides here may also be premixed and then added as a mixture.

The sequence in which the carbodiimides are mixed in may be selected freely. Furthermore, the addition of the carbodiimides may also be made after the production of the biobased plastic.

Mixing assemblies for the purposes of the invention are, for example, an extruder or compounder.

The present invention additionally provides a method for producing biobased plastics for electronics, automotive, construction, transport, household, office requisites or “severe conditions” applications by adding the biobased plastics of the invention or by forming the biobased plastics articles for electronics, automotive, construction, transport, household, office requisites or “severe conditions out of it

The present invention additionally provides for the use of the biobased plastics of the invention in long-lasting applications, such as electronics, automotive, construction, transport, household, e.g. as bath utensils, or office requisites, or for “severe conditions” applications, such as under the sterile conditions in medicine, for example

The examples below serve to elucidate the invention, without having any limiting effect.

### WORKING EXAMPLES

Chemicals used:

CDI I: a sterically hindered aromatic carbodiimide (Stabaxol® I LF) having an NCN content of at least 10.0%, from Rhein Chemie Rheinau GmbH.
CDI II: a sterically hindered aromatic polymeric carbodiimide (Stabaxol® P) having an NCN content of 13.5%, from Rhein Chemie Rheinau GmbH.
Carbodilite® LA-1 (H12MDI-PCDI): a polymeric aliphatic carbodiimide having an NCN content of 15.8%, from Nisshinbo.
Joncryl ADR 4368: oligomeric chain extender from BASF.

### Polyhydroxyalkanoate (PHA): Mirel P 1003

Apparatus used:

The carbodiimides were incorporated into the polyhydroxyalkanoate using a ZSK 25 twin-screw laboratory extruder from Werner and Pfleiderer.

The amounts of additive used and the nature of the additive used are apparent from Table 1.

The standard F3 test specimens were produced on an Arburg Allrounder 320 S 150-500 injection-moulding machine.

For the hydrolysis test on polyhydroxyalkanoate (PHA), the standard F3 test specimens were stored in water at a temperature of 85° C. and, after different time units, a tensile test was carried out in order to ascertain the tensile strength. The hydrolysis protection period describes the lifetime of the test specimens: after how many days under test conditions the tensile strength has taken on a value of less of 5 MPa.

The melt volume rate (MVR) was measured using a model MI 4 instrument from Göttfert. Measurement temperature: 175° C. Test weight: 2.16 kg. Melting time: 5 minutes. The residual moisture content of the polymer pellets is not more than 100 ppm.

TABLE 1

| | | Hydrolysis | |
|---|---|---|---|
| | | protection | MVR |
| Sample | Additives used | period [d] | [ccm/10 min] |
| 1 | PHA direct from the drum | 6 | 7.4 |
| 2 | PHA 1 × extruded | 6 | 24.9 |
| 3 | 0.5% CDI I + 0.5% CDI II | 13 | 10.2 |
| 4 | 0.75% CDI I + 0.75% CDI II | 25 | 12.3 |
| 5 | 0.5% CDI I + 1.0% CDI II | 25 | 11.8 |
| 6 | 1.0% CDI I + 0.5% CDI II | 25 | 12.9 |
| 7 | 0.5% CDI I + 0.5% H12MDI- | 13 | 10.9 |
| | PCDI | | |
| 8 | 0.75% CDI I + 0.75% H12MDI- | 14 | 12.3 |
| | PCDI | | |
| 9 | 0.5% CDI I + 1.0% H12MDI- | 14 | 12.4 |
| | PCDI | | |
| 10 | 1.0% CDI I + 0.5% H12MDI- | 14 | 12.2 |
| | PCDI | | |
| 11 | 0.1% Joncryl ADR 4368 | 6 | 16.3 |
| 12 | 0.25% Joncryl ADR 4368 | 6 | 17.0 |
| 13 | 0.5% Joncryl ADR 4368 | 6 | 19.2 |

Clearly apparent was the advantageous effect of the inventive mixtures of at least one monomeric aromatic carbodiimide (CDI I) and at least one oligomeric aromatic and/or polymeric aromatic carbodiimide (CDI II). The stability is increased significantly particularly in the case of a mixture of an aromatic carbodiimide and an aromatic polymeric carbodiimide.

What is claimed is:

1. Biobased plastics comprising a combination of at least one polyhydroxyalkanoate and at least one aromatic monomeric carbodiimide and at least one aromatic oligomeric and/or aromatic polymeric carbodiimide.

2. Biobased plastics according to claim 1, characterized in that the polymeric and/or oligomeric carbodiimide is a compound of the general formula (II),
R²—(—N═C═N—R′—)ₘ—R³ (II),
in which
R′ is an aromatic and/or araliphatic radical, R′ within the molecule is identical or different and, in the case of different combinations, each of the aforementioned radicals may be combined arbitrarily with one another, R′ in the case of aromatic oligomeric or polymeric carbodiimides may carry no aliphatic and/or cycloaliphatic and/or aromatic substituents having at least one carbon atom, it also being possible for these substituents to carry heteroatoms, or may carry such substituents in at least one position ortho to the aromatic carbon atom which carries the carbodiimide group,
R²=C₁-C₁₈-alkyl, C₅-C₁₈-cycloalkyl, aryl, C₇-C₁₈-aralkyl, —R′—NH—COS—R⁴, —R′COOR⁴, —R′—OR⁴, —R′—N(R⁴)₂, —R′—SR⁴, —R′—OH, R′—NH₂, —R′—NHR⁴, —R′-epoxy, R′—NCO, —R′—NHCONHR⁴, —R′—NHCONR⁴R⁵ or —R′—NHCOOR⁶ and
R³=—N═C═N-aryl, —N═C═N-alkyl, —N═C═N-cycloalkyl, —N═C═N-aralkyl, —NCO, —NHCONHR⁴, —NHCONHR⁴R⁵, —NHCOOR⁶, —NHCOS—R⁴, —COOR⁴, —OR⁴, epoxy, —N(R⁴)₂, —SR⁴, —OH, —NH₂, —NHR⁴,
and in R² and R³, independently of one another, R⁴ and R⁵ are identical or different and are a C₁-C₂₀-alkyl-, C₃-C₂₀-cycloalkyl, C₇-C₁₈-aralkyl radical, oligo-/polyethylene glycols and/or oligo-/polypropylene glycols and R⁶ has one of the definitions of R⁴ or is a polyester radical or a polyamide radical, and
in the case of oligomeric carbodiimides, m corresponds to an integer from 1 to 5, and
in the case of polymeric carbodiimides, m corresponds to an integer >5.

3. Biobased plastics according to claim 1 or 2, characterized in that the polymeric and/or oligomeric carbodiimide comprises compounds of the formula (I) in which R′ identically corresponds to 1,3-substituted 2,4,6-triisopropylphenyl and/or 4,4′-substituted dicyclohexylmethane-4,4′ derivatives and/or isophorone derivatives and/or 1,3-bis(1-methyl-1-isocyanatoethyl)benzene and/or tetramethyl xylylene derivatives and/or 2,4-substituted tolylene and/or 2,6-substituted tolylene and/or mixtures of 2,4- or 2,6-substituted tolylene.

4. Biobased plastics according to one or more of claims 1 to 3, characterized in that the monomeric carbodiimide is sterically hindered.

5. Biobased plastics according to one or more of claims 1 to 4, characterized in that the monomeric carbodiimide is a compound of the formula (III)
R″—N═C═N—R′″ (III)
in which
R″ and R′″ are identical or different and correspond to aryl, C₇-C₁₈-aralkyl,
R″ and R′″, in the case of an aromatic radical, may carry no aliphatic and/or cycloaliphatic and/or aromatic substituents having at least one carbon atom, it also being possible for the substituents to carry heteroatoms, or may carry such substituents in at least one position ortho to the aromatic carbon atom which carries the carbodiimide group.

6. Biobased plastics according to claim 5, characterized in that the aromatic monomeric carbodiimide is a sterically hindered aromatic carbodiimide of the general formula (IV), 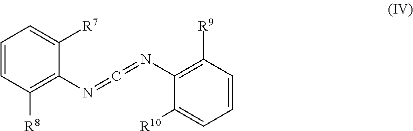
in which
R⁷ to R¹⁰ independently of one another are H, C₁- to C₂₀-alkyl, C₃- to C₂₀-cycloalkyl, C₆- to C₁₅-aryl or a C₆- to C₁₅-aralkyl radical which optionally may also contain heteroatoms.

7. Biobased plastics according to one or more of claims 1 to 6, characterized in that the polyhydroxyalkanoate is a compound of the formula (I) 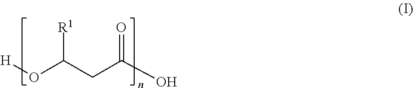
in which
R¹ corresponds to a C₁- to C₁₄-alkyl radical.

8. Method for producing the biobased plastics according to one or more of claims 1 to 7, characterized in that at least one polyhydroxyalkanoate is mixed with at least one monomeric aromatic and at least one oligomeric aromatic and/or polymeric aromatic carbodiimide in a mixing assembly.

9. Method for producing biobased plastics for electronics, automotive, construction, transport, household, office requisites or “severe conditions” applications by using the biobased plastics according to one or more of claims 1 to 7.
